(19) United States
(12) Patent Application Publication
(10) Pub. No.: US 2004/0059726 A1
(43) Pub. Date: Mar. 25, 2004

(54) Context-sensitive wordless search

(76) Inventors: Jeff Hunter, San Jose, CA (US); Ranjit Padmanabhan, Saratoga, CA (US)

Correspondence Address: MARGER JOHNSON & McCOLLOM, P.C., 1030 S.W. Morrison Street, Portland, OR, 97205, US

(21) Appl. No.: 10/659,557

(22) Filed: Sep. 9, 2003

Related U.S. Application Data
(60) Provisional application No. 60/409,659, filed on Sep. 9, 2002.

(51) Int. Cl. G06F 7/00

(52) U.S. Cl. 707/3

(57) ABSTRACT

Embodiments of the invention provide the searcher a unique method of interacting with one or more documents to build a context-sensitive query that can retrieve additional documents that are closer to the searcher's needs. Embodiments of the invention do not require the searcher to enter any text and translate the searcher's intent into complex queries that will be executed by existing search engines. Embodiments of the invention iteratively modify the context-sensitive query and eventually retrieve a document that satisfies the searcher's requirements.

### CROSS REFERENCE TO RELATED APPLICATIONS

This application claims priority from U.S. Provisional Application No. 60/409,659, filed on Sep. 9, 2002, entitled “CONTEXT-SENSITIVE WORDLESS SEARCH,” the contents of which are hereby incorporated by reference in their entirety for all purposes.

### BACKGROUND OF THE INVENTION

1. Technical Field of the Invention

This disclosure relates in general to search methodologies, and, in particular, to Internet search methodologies.

2. Description of the Related Art

Conventional search engines require users, or searchers, to initiate a search either by entering text queries that describe their needs, or alternatively by navigating hierarchical systems of classifications to locate relevant documents. The list of documents that is returned by a search engine may be referred to as a result set, and the individual documents that make up the result set may be referred to as result set items.

Once an initial result set is obtained, searchers frequently determine that a modified search is necessary. This is typically done by making slight modifications to the search parameters, or by using various relevance feedback mechanisms to indicate the desirability of individual result set items.

There are significant drawbacks to these conventional search methods. The dominant ones include text-entry and context insensitivity. Text-entry requires that the searcher construct a query that is compliant with the particular syntax and grammar supported by the underlying search engine.

Context insensitivity arises because conventional search engines only permit the searcher to supply relevance feedback at the result set item level. For example, after an initial result set is obtained, a conventional search might allow a searcher to further refine the search among the result set items to obtain an even smaller result set that is a subset of the original result set. This is known as coarse granularity. However, the conventional methods do not allow the searcher to specify the relevancy of different structural elements that are found within individual result set items. This ability may be referred to as fine granularity. In other words, conventional search methods are unable to refine the search in a context-sensitive manner.

Embodiments of the invention address these and other limitations of the conventional art.

### BRIEF DESCRIPTION OF THE DRAWINGS

FIG. 1 is a flowchart illustrating basic processes followed by embodiments of the invention during construction and refinement of a search.

FIG. 2A is a flowchart illustrating some processes that are performed at the server, client, and searcher layers according to an embodiment of the invention.

FIG. 2B is a block diagram illustrating a computer system that may be used to implement the server and client layers of FIG. 2A.

FIG. 3 is a computer program pseudo-code listing that illustrates the document structure detection process according to another embodiment of the invention.

FIG. 4A is a reproduction of a product web page typically found on the Internet that illustrates a type of document that may be searched using embodiments of the invention.

FIG. 4B is a text listing that illustrates a relevant XML fragment for the document of FIG. 4A.

FIG. 4C is a text listing that illustrates an XQuery fragment for the query generated by an embodiment of the invention using the XML fragment of FIG. 4B.

FIG. 5A is a reproduction of a resume found using a typical Internet search engine and represents another type of document that may be searched using embodiments of the invention.

FIG. 5B is a text listing that illustrates a relevant HTML fragment for the document of FIG. 5A.

FIG. 5C is a text listing that illustrates a XQuery fragment for the query generated by an embodiment of the invention using the HTML fragment of FIG. 5B.

### DETAILED DESCRIPTION OF THE INVENTION

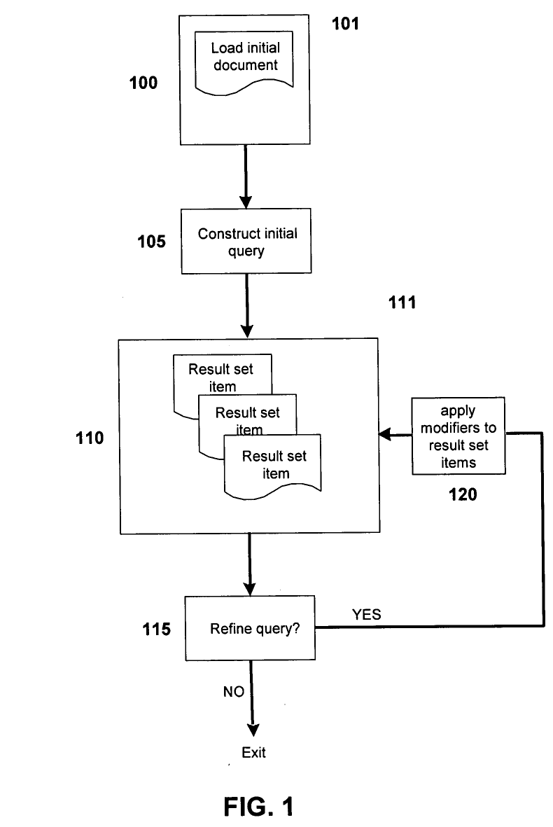

FIG. 1 is a flowchart illustrating basic processes followed by a search generator according to an embodiment of the invention during construction and refinement of a search.

In process 100, a searcher invokes a web page framework that can be viewed within a web browser. The searcher then identifies one initial document 101 that exemplifies the type of document that he is searching for. This initial document 101 is loaded into the framework. The framework determines, to the extent possible, the structure of the document 101. Specifically, the framework examines the exemplary document 101, identifying the structural tags (if any) as well as the elements, attributes, and data contained within the tags. As is well-known in the art, structural tags are commands that are inserted into a document that specify how the document, or portions of the document, should be formatted. Some embodiments of the invention may also process the document header.

For example, according to this embodiment, the exemplary document 101 may be categorized as one of four types depending on the level of structure present in the document. Other embodiments of the invention may use more or fewer categories.

In this embodiment, a Type I document is one that has no discernible structure, that is, it has no structural tags and, when displayed, appears to a viewer to have no visible structure. A Type II document has no structural tags, but nonetheless exhibits a visible structural pattern. A Type III document is one with structural tags, for example, a document created using a physical markup language such as hypertext markup language (HTML) or extensible HTML (XHTML). Type III documents manifest a physical structure such as form, style, or presentation, but there is no explicit semantic data. This means that while the structural tags indicate how the text and graphic images of a web page should be displayed, the tags convey no additional information about the data.

Type IV documents are those that contain logical as well as physical markup. Logical markup uses tags that are not merely structural, the tags also convey additional information about the data. For example, in HTML (a physical markup language), the letter “p”, when used as a tag, indicates that the data on that line starts a new paragraph, but it does not indicate anything about the data itself. However, in a logical markup language such as Extensible Markup Language (XML), the word “phonenum” could be used as a tag indicating that the data that followed was a phone number. Any document that complies with an Extensible Markup Language (XML) schema that represents logical data is a Type IV document. Logical markup allows a Type IV document to be processed purely as data by another program or it can be simply displayed, like a Type III document.

Once the initial document 101 is loaded and structurally analyzed at process 100, an initial query is constructed in process 105. To aid in this process, the embodiment provides tools and modifiers to the searcher so that he may select fragments of the initial document 101 and apply a relevancy modifier to that fragment. This particular embodiment allows the searcher to select fragments of the document 101 using the conventional Select/Highlight feature that is standard on most computer mice. Alternatively, the text fragments may be selected using other conventional devices such as a keyboard, a laser pointer, a trackball, a joystick, or a touchpad that makes contact with a stylus, a finger, or some other object. The text fragments might also be specified using voice recognition software that detects the searcher's voice and associates spoken words with the corresponding text fragments. Once the text fragment is selected, the searcher associates a relevancy modifier with that fragment. The modifiers allow the searcher to indicate the relevancy of the selected fragment. Examples of possible modifiers may be “more like this,” “less like this,” “not like this,” or “exactly like this.” The embodiment is able to store all selected fragments and their respective associated modifiers. Once the searcher has completed this relevance feedback process, the embodiment is able to create a composite query using the analysis of the document structure and the selected fragments with their associated modifiers.

In process 110, the query created by the search generator is then dispatched to a search engine, which returns a result set that contains one or more individual result set items 111, each result set item 111 having the selected text fragment. The result set items 111 may be ordered according to how closely the text fragment in the result set item matches the structure, context, and the identified relevancy of the text fragment found in the initial document 101.

For example, using the classification system described above, assume that the initial document 101 was a Type IV document, and that the result set items 111 are assigned a relevancy score based on a one hundred point scale. All other things being equal, if the result set contained a Type III document and a Type II document, the Type III document is assigned a higher score (e.g., 60-80 range) compared to the Type II document (e.g., 40-60 range). If a Type IV result set item existed, it would have a score in the 80-100 range. For example, if the result set contained several Type IV documents, then a Type IV result set item containing a selected text fragment with a “more like this” relevancy modifier would have a higher rating (e.g., 95) than a Type IV result set item having a “less like this” relevancy modifier (e.g., 85).

Embodiments of the invention may also allow the searcher to specify whether a structural match in a result set item 111 takes priority over a relevancy match, or vice versa. For example, continuing with the example above of a Type IV initial document 101, a Type III result set item 111 containing a “more like this” text fragment may have a higher rating (e.g., 82) than a Type IV result set item 111 containing a “less like this” text fragment (e.g., 78).

It will be appreciated that according to embodiments of the invention, there are any number of ways to rank a result set item 111 based on how closely the text fragment in the result set item matches the structure, context, and the identified relevancy of the text fragment found in the initial document 101. Consequently, especially where a Type IV document with logical and physical markup is concerned, a match is not determined simply by whether selected text appears in a document, but also by the underlying language, subject matter, and domain of the initial document 101.

In process 115, the searcher may elect to quit his search or to modify the original query in process 120. In process 120, the modified query is submitted to the search engine and an updated result set is generated. The searcher may once again select text fragments in any or all of the individual result set items 111 and associate modifiers to each of those text fragments. These modifications are then combined with the original query to construct the refined query. Processes 110, 115, and 120 are repeated iteratively until the searcher terminates the process, having either found the information of interest or having run out of available time or documents. One difference between this embodiment and that of conventional processes is that the selections are consistent across all the result set items 111 that the searcher inspects.

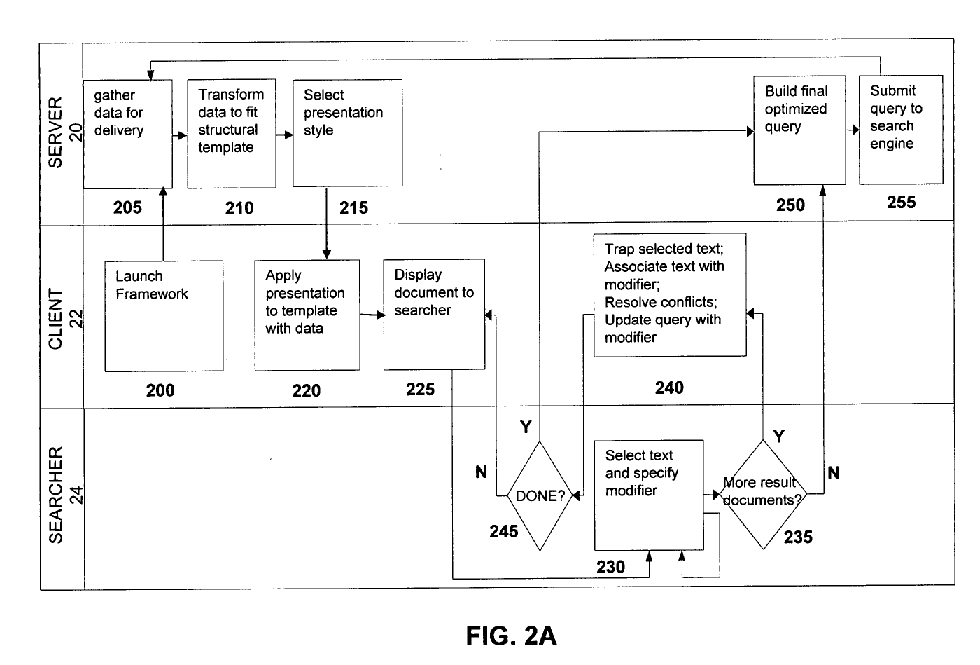

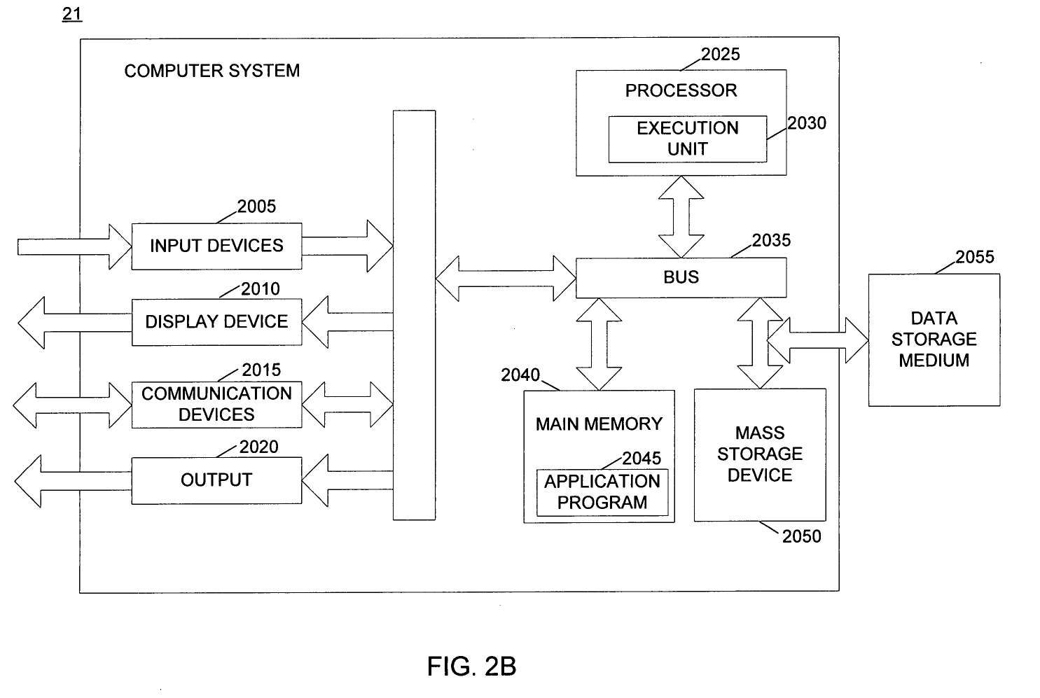

Conceptually, two of the primary processes for implementing embodiments of the invention include a Document Structure Detection (DSD) process and a Query Creation (QC) process. FIG. 2A is a flowchart illustrating elements of the DSD and QC processes that are performed at the server layer 20, client (web browser) layer 22, and searcher layer 24 according to an embodiment of the invention. For example, processes 250 and 255 in the server layer 20 are elements of the QC process while the processes 200 through 220 in the server layer 20 and client layer 22 are elements of the DSD process. Alternative embodiments may distribute elements of the DSD and QC processes differently between the client layer 20 and server layer 22, or use an auxiliary server where it is not possible to install components behind a corporate firewall. The strategy may be implemented using existing tools and technologies, including XML, XSL (Extensible Stylesheet Language), XQuery (an XML-based method of querying databases), JavaScript, and Java applets.

Walking through the implementation strategy illustrated in FIG. 2A, the search generator is launched at process 200 as a framework at the client (web browser) level 22. It is assumed that this process is initiated by the searcher who has already found an exemplary document before requesting a search for other relevant documents. The server layer 20 gathers the data from the exemplary document in process 205, analyzes the structural information present in the data in process 210, and selects the presentation style in process 215. At the client layer 22, the presentation style is applied to the exemplary document in process 220 and displayed to the searcher in process 225. In process 230 the searcher selects text fragments from the displayed document and specifies the appropriate modifier to indicate the relevancy of the text document to the searcher. In this embodiment, process 235 returns a NO after the framework is launched for the first time because there is only one exemplary document. Thus, the QC process is performed at process 250 in the server layer 20 and the search query submitted to the search engine in process 255.

After the first search, the result set items generated by the search engine are inserted back into the flow at process 205, and the data structure of the result set items are analyzed in process 210 and a presentation style is selected for each result set item in process 215. As before, the presentation style is applied to the result set items in process 220 and the first result set item displayed to the searcher in process 225. According to this embodiment of the invention, the first result set item is also the one that is most relevant. That is, using the classification levels discussed above, if a Type IV document is the initial exemplary document then the result set items are arranged with Type IV documents appearing first, Type III documents appearing next, and so on. As before, the searcher selects text fragments and associates a modifier with the text fragment in process 230. At process 235 there will typically be more result set items to review, so the existing query is modified and updated in process 240. If the searcher elects to quit modification of the query at process 245, the query is finalized at process 250 and sent to the search engine once again (process 255). If the searcher elects to continue modification of the query at process 245, the next document is displayed (process 225) and the searcher continues to select text fragments and associate relevancy modifiers to the text fragments until he is satisfied with the search results.

FIG. 2B is a block diagram illustrating a computer system 21 that may be used to implement the server and client layers 20 and 22 of FIG. 2A. The computer system 21 includes a processor 2025, main memory 2040, mass storage device 2050, and a bus 2035. The processor 2025 includes an execution unit 2030, and an application program 2045 resides on the main memory 2040. Input devices 2005, display device 2010, communication devices 2015, and output devices 2020 are also included with computer system 21. Data transfer is accomplished between the components of computer system 21 with bus 2035. External data storage medium 2055 is also available. The application program 2045 includes the software that directs the computer system 21 to perform the functions necessary to implement embodiments of the invention.

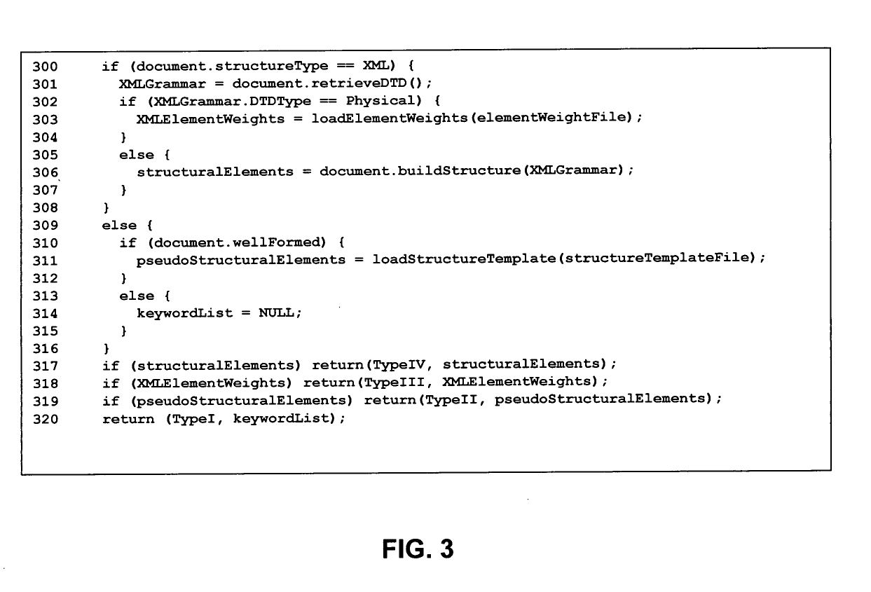

FIG. 3 is a computer program pseudo-code listing that illustrates the DSD process according to another embodiment of the invention. As was discussed previously, embodiments of the invention categorize an initial document according to its structure. In the case described above where documents range from a Type IV (most structured) to a Type I (least structured), the pseudo-code of FIG. 3 illustrates the DSD flow. Beginning with line 300, the embodiment checks the structure type of the searcher-provided initial document to see if it is of an XML compatible type. If line 300 returns true, the tags for the document are retrieved and assigned to the variable XMLGrammar (line 301) and the decision paths outlined by the if-then-else structure of lines 302-308 are traversed before continuing at line 317. On the other hand, if line 300 is false, lines 309-316 are executed instead of lines 302-308.

If the initial document is of an XML-compatible type (line 300=true), the next if statement on line 302 checks for physical markup in the variable XMLGrammar. If true, the variable XMLElementWeights is assigned a pre-determined weighting scheme from the external configuration file elementWeightFile (line 303). The external configuration file elementWeightFile specifies the tags that have meaning and assigns weights to those tags. In this case, the document structure is of a Type III, and the variable elementWeightFile may be used to help construct a weighted Boolean query.

On the other hand, if line 302 returns false, then the document is a Type IV document and the variable structuralElements is assigned the structural data tag information. Type IV documents have the highest degree of structure and therefore result in the best quality queries with the highest degree of precision.

If line 300 returns false, then the decision branches represented by lines 309-317 are followed. This means that the initial document is not of a XML compatible type, and has no tags. However, if the initial document is well-formed and has an observable structural pattern (line 310), the variable pseudoStructuralElements is generated using an external template and the embodiment can associate each of the terms with the context defined in the template. The variable pseudoStructuralElements is used to generate a context-sensitive query that includes Boolean operators and containment criteria. One example of a containment criterion is that a fragment must occur in a specific section of the document, such as in the title.

If line 310 is false, then the initial document is of a Type 1, having no discernible structural definition. In this case, the variable keywordlist is assigned the null set (line 314). Later on, when the searcher identifies fragments of the initial document and attaches modifiers to those fragments, a simple Boolean query without any context associated with the terms in the query is generated. This is the standard default search condition for conventional search engines.

Based on the structure inferred by the DSD process, the fragments selected by the searcher, and the modifiers that the searcher associates with the fragments, the QC process builds a query. As illustrated in FIG. 1 and FIG. 2, query building is an incremental process influenced by all previous selections. It concludes when the searcher is satisfied that he has expressed his intent. At that point, the query is submitted to the underlying search engine, which returns a new collection of result set items, repeating the process. Embodiments of the invention accomplish query building by extending the lists of modifiers, by removing duplicate modifiers, and by resolving conflicts such as the same fragment appearing with mutually exclusive modifiers. For example, the searcher may inadvertently associate a selected fragment with both the modifier “less relevant” and the modifier “more relevant.”

In the following paragraphs, several real-world examples of context-sensitive queries generated by embodiments of the invention are discussed. Currently, XQuery is emerging as a new XML Query language standard. XQuery is able to express arbitrarily complex search queries including Boolean operators, containment, comparison of various data types, etc. In the following examples the QC process will generate queries in XQuery, and the queries will then be submitted to search engines that support the standard. The fact that the example queries are generated in XQuery should not be construed as limiting in any way.

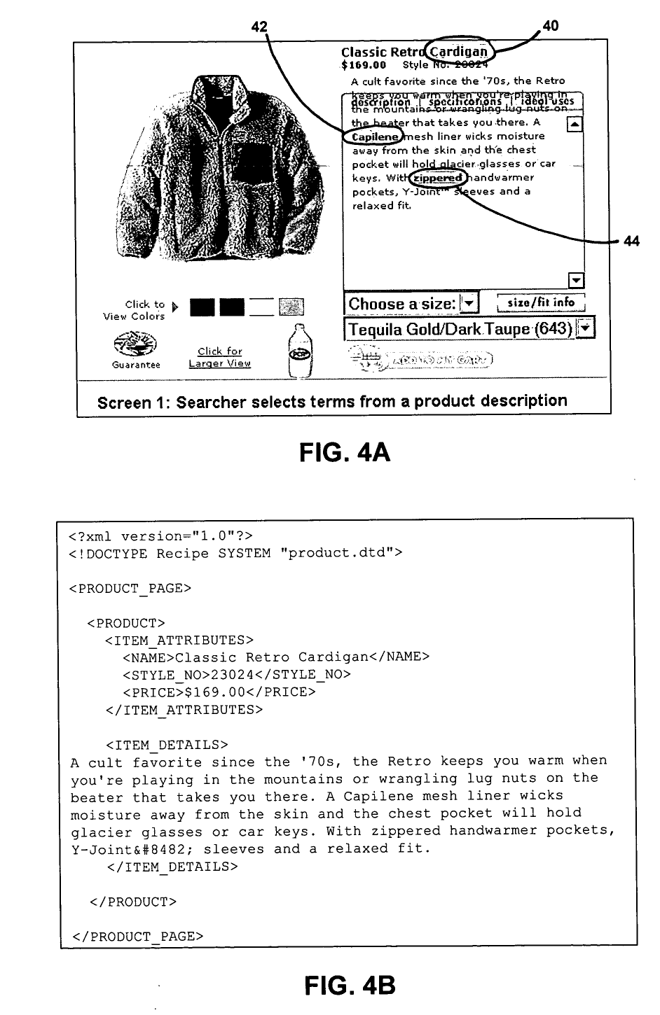

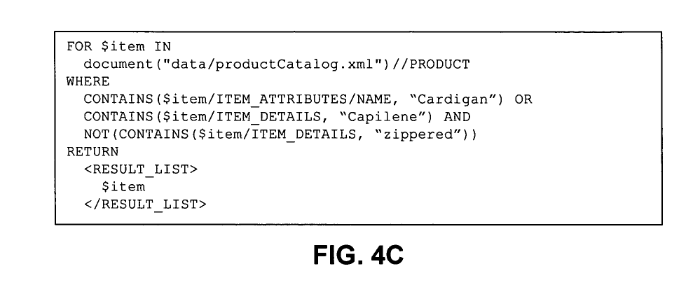

FIGS. 4A, 4B, and 4C illustrate an example of a search generated by an embodiment of the invention from a retail web page that has a Type IV document structure. FIG. 4A shows the example retail web page. As was explained above, the structure of the web page in FIG. 4A is analyzed through the DSD process. For this example, it is assumed that the embodiment of the invention was able to infer that the underlying structure was compliant with the XML standard for representing product information. The relevant fragment of the structured XML document is illustrated in FIG. 4B.

Next, referring to FIG. 4A, the searcher selects the terms “Cardigan” (40), “Capilene” (42), and “zippered” (44) with the selection tool provided by the embodiment of the invention. In this embodiment, the tool allows the searcher to highlight these terms in a color that corresponds to their associated relevancy modifier. In this case, “Cardigan” (40) and “Capilene” (42) are highlighted in green to indicate that they have relevancy modifiers of “more like this”, while the term “zippered” (44) is highlighted in red to indicate that it carries a relevancy modifier of “less like this.”

Once the searcher has selected all the fragments of interest and associated relevancy modifiers with them, the DSD process designates the selections in a manner that links them with the context exhibited by the XML document of FIG. 4B. For example:

1. MLT (‘Cardigan’ in PRODUCT_PAGE/PRODUCT/ITEM_ATTRIBUTES/NAME)

2. MLT (‘Capilene’ in PRODUCT_PAGE/PRODUCT/ITEM_DETAILS)

3. LLT (‘zippered’ in PRODUCT_PAGE/PRODUCT/ITEM_DETAILS)

The QC module then uses these query modifiers to generate an XQuery language query, a fragment of which is illustrated by FIG. 4C. The XQuery query is then forwarded to a search engine that retrieves a result set from a pool of available documents.

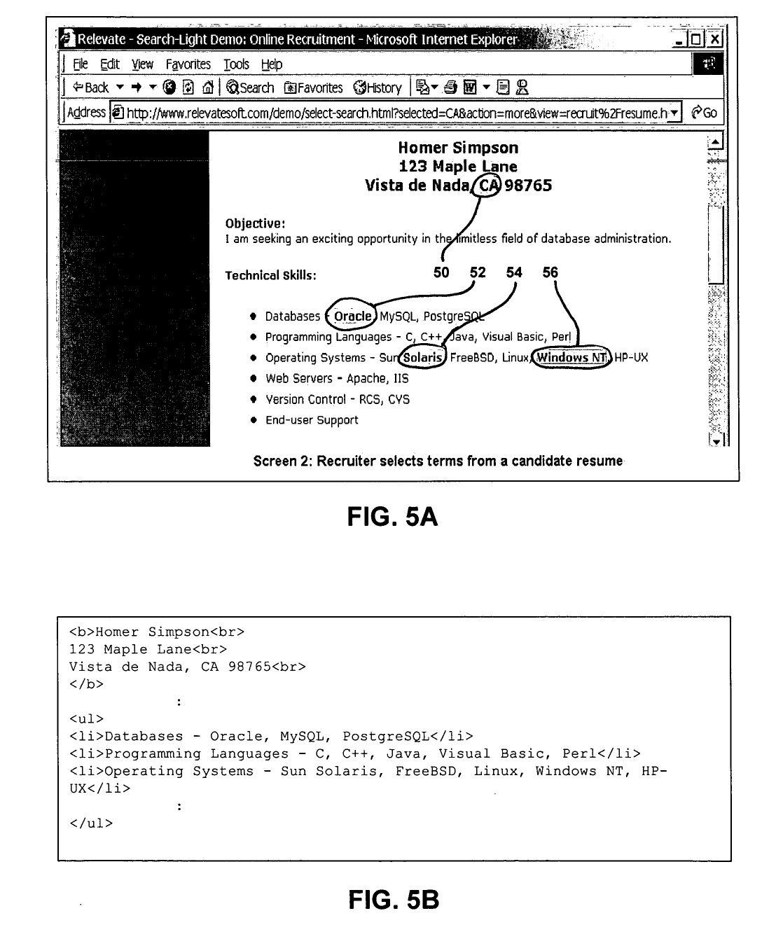

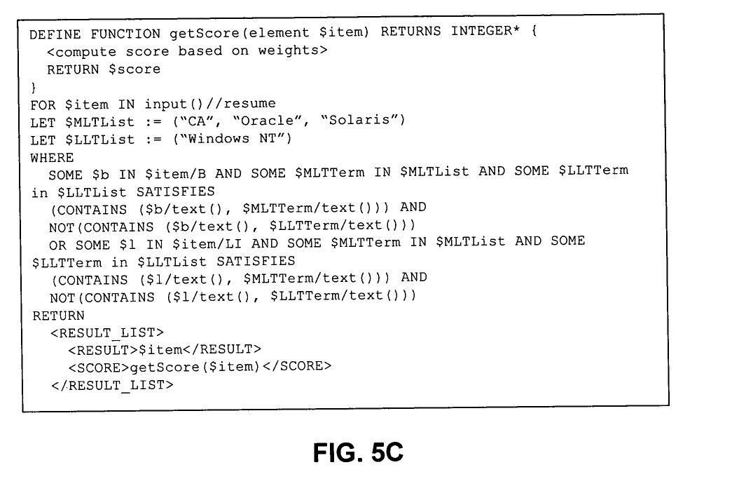

FIGS. 5A, 5B, and 5C illustrate another example of a search generated by an embodiment of the invention from a resume published on a web page. In this example the searcher is a recruiter trying to find a potential candidate for a job opening. FIG. 5A shows the example on-line resume. As explained above, the structure of the web page in FIG. 5A is analyzed through the DSD process. For this example, it is assumed that the embodiment of the invention found only HTML present in the document, that is, according to the example classification scheme described earlier, a Type III document. The relevant HTML fragment of the candidate resume document of FIG. 5A is illustrated in FIG. 5B.

As in the previous example, the searcher uses the tools provided by the embodiment of the invention to select fragments of the candidate resume and associate relevancy modifiers to them. In this case, the searcher highlights terms 50, 52, and 54 (“CA,” “Oracle,” and “Solaris”) in green to indicate a relevancy of “more like this” while term 56 (“Windows NT”) is highlighted in red to indicate a relevancy of “less like this.”

Since the markup is physical, there is no underlying logical structure to the highlighted content. However, in many cases physical tags can reflect the importance of terms. For example, a term in the <TITLE> tag is generally of greater significance than one that is part of the <BODY> text. In some embodiments of the invention, the importance of physical tags can be specified in a separate configuration file, from which a weighted query may be generated.

After the recruiter has made his selections, as shown in FIG. 5A, the DSD process will designate the selections contextually as follows:

1. MLT (‘CA’ in a <b> . . . <b> tag)

2. MLT (‘Oracle’ in a <li> . . . </li> tag)

3. MLT (‘Solaris’ in a <li> . . . </li> tag)

4. LLT (‘Windows NT’ in a <li> . . . </li> tag)

For this example, assuming that a separate configuration file specifies that terms within a bold tag <b> . . . <b> have a weight of 3, and those within a list tag <li> . . . </li> have a weight of 2, the QC process will generate a scored query based on the weighted terms. The XQuery fragment for this weighted query is illustrated in FIG. 5C.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A method of performing a context-sensitive search comprising:
accepting a selection of a first document;
accepting a selection of a first term from within the first document;
determining a context of the first term with respect to the first document;
choosing at least two documents that contain the first term; and
ranking the at least two documents that contain the first term according to how closely a context of the first term with respect to the at least two documents matches the context of the first term with respect to the first document.

2. The method of claim 1, wherein accepting a selection of a first term from within the first document comprises:
accepting a selection of the first term in response to a device chosen from the group consisting of a computer mouse, a trackball, a joystick, a touchpad, and a laser pointer.

3. The method of claim 1, wherein accepting a selection of a first term from within the first document comprises:
accepting a selection of the first term in response to a sound.

4. The method of claim 1, further comprising:
accepting a selection of a second term from the first document;
determining a context of the second term with respect to the first document;
associating a first modifier that is indicative of the relevancy of the first term with the first term;
associating a second modifier that is indicative of the relevancy of the second term with the second term;
instead of choosing at least two documents that contain the first term, choosing at least two documents that contain the first and second terms; and
ranking the at least two documents that contain the first and second terms according to how closely a context of the first and second terms with respect to the at least two documents matches the context of the first and second terms with respect to the first document, and according to the first and second modifiers.

5. The method of claim 4, wherein determining a context of the first term with respect to the first document and determining a context of the second term with respect to the first document comprises:
identifying whether any structural tags exist in the first document.

6. The method of claim 5, wherein identifying whether any structural tags exist in the first document comprises:
determining whether the first document is characterized as one belonging to a group consisting of a document with no structural tags and no discernible structure, a document with no structural tags and a discernible structure, a document with a structural tag that has physical markup, and a document with a structural tag that has physical and logical markup.

7. The method of claim 6, wherein a document with a structural tag that has physical markup comprises a HTML document.

8. The method of claim 6, wherein a document with a structural tag that has physical and logical markup comprises a document that complies with an XML schema.

9. The method of claim 4, further comprising:
accepting a selection of a third term from one of the at least two documents that contain the first and second terms;
determining a context of the third term with respect to the one of the at least two documents that contain the first and second terms;
assigning a third modifier to the third term based upon the relevancy of the third term;
choosing at least two documents that contain the first, second, and third terms; and
ranking the at least two documents that contain the first, second, and third terms according to how closely a context of the first and second terms with respect to the at least two documents that contain the first, second, and third terms matches the context of the first and second terms with respect to the first document, according to how closely a context of the third term with respect to the at least two documents that contain the first, second, and third terms matches the context of the third term with respect to the one of the at least two documents that contain the first and second terms, and according to the first, second, and third modifiers.

10. The method of claim 4, wherein associating a first modifier with the first term and associating a second modifier with the second term comprise:
associating a modifier with the first term and with the second term that is chosen from the group consisting of more relevant, less relevant, not relevant, and exactly relevant.

11. A method comprising:
assigning a first document a complexity rating that is indicative of the complexity of the first document's structure;
associating a relevance indicator with a first element that is contained within the first document; and
finding a second document based upon the second document's complexity rating being no greater than the first document's complexity rating, based upon a relationship between the first element and the first document being the same as a relationship between a second element in the second document and the second document, and based upon the similarity between the first element and the second element.

12. The method of claim 11, wherein finding the second document additionally comprises:
constructing a query; and
sending the query to a search engine that uses the query to find the second document.

13. The method of claim 11, wherein associating the relevancy indicator with the first element comprises accepting an input in response to a device that performs a highlighting function.

14. The method of claim 11, wherein associating the relevancy indicator with the first element comprises assigning a less relevant indicator to the first element.

15. The method of claim 11, wherein associating the relevancy indicator with the first element comprises assigning a more relevant indicator to the first element.

16. The method of claim 11, wherein assigning the first document a complexity rating that is indicative of the complexity of the first document's structure comprises:
assigning the first document a first rating if the first document has no structural tags and no discernible structure;
assigning the first document a second rating if the first document has no structural tags but a discernible structural pattern;
assigning the first document a third rating if the first document has structural tags with physical markup; and
assigning the first document a fourth rating if the first document has structural tags with physical and logical markup.

17. The method of claim 12, further comprising:
associating a relevance indicator with a second element that is contained within the second document; and
modifying the query by incorporating the second element and its relevance indicator.

18. A device-readable medium that, when read, causes a first device to perform processes comprising:
storing a file that contains structural information about a document;
storing at least one fragment from the document in response to a first external input;
storing a modifier that indicates the relevancy of the at least one fragment in response to a second external input;
forming a context-sensitive search query based upon the modifier, the at least one fragment, and the file;
sending the context-sensitive search query to a second device to find a first plurality of result set items that conforms to the context-sensitive search query.

19. The medium of claim 18, where analyzing the structure of the document further comprises:
determining whether the document has logical markup data, physical markup data, and an observable structural pattern.

20. The medium of claim 18, further causing the first device to perform processes further comprising:
storing a result set item fragment from one of the plurality of result set items in response to a third external input;
storing another modifier that indicates the relevancy of the result set item fragment in response to a fourth external input;
forming a modified context-sensitive query based upon the result set item fragment and the another modifier; and
sending the modified context-sensitive search query to the second device that finds a second plurality of result set items conforming to the modified context-sensitive search query.

21. A method of performing a context-sensitive search comprising:
under control of a client system,
displaying a document;
associating a text fragment in the document with a modifier based on inputs from a searcher;
sending a request to find other documents that contain the text fragment to a server system; and
under control of the server system,
receiving the request;
building a query that is responsive to the context of the text fragment in the document and that is also responsive to the modifier; and
submitting the query to a search engine.

22. The method of claim 21, wherein the server system additionally:
receives results from the search engine; and
sends the received results to the client system.
